(19) United States
(12) Patent Application Publication
(10) Pub. No.: US 2009/0157822 A1
(43) Pub. Date: Jun. 18, 2009

(54) SYSTEM AND METHOD FOR HIGH EFFICIENCY TUNNELLING FOR AGILE MEETINGS

(75) Inventors: Al Chakra, Apex, NC (US); Siddharth P. Desai, Raleigh, NC (US); Zachary J. Marlow, Raleigh, NC (US); Tejaswini R. Patil, Raleigh, NC (US)

Correspondence Address: STRATEGIC PATENT GROUP, P.C., P.O. BOX 1329, MOUNTAIN VIEW, CA, 94042, US

(73) Assignee: INTERNATIONAL BUSINESS MACHINES CORPORATION, Armonk, NY (US)

(21) Appl. No.: 11/955,626

(22) Filed: Dec. 13, 2007

(51) Int. Cl. G06F 15/16

(52) U.S. Cl. 709/206

(57) ABSTRACT

A method and system provides sub-electronic meetings by: providing the main electronic meeting for a group of attendees over a first channel in a network, the main electronic meeting managed by a moderator; sending a request from the moderator to an electronic meeting service to create sub-electronic meetings for a subgroup of attendees; and providing the sub-electronic meeting over a separate second channel in the network for the subgroup, the sub-electronic meeting occurring simultaneously within the main electronic meeting without disconnecting the subgroup from the main electronic meeting. A first graphic user interface (GUI) for the main electronic meeting is provided to each of the group of attendees. A second GUI for the sub-electronic meeting is provided to each of the subgroup of attendees. The subgroup of attendees is able to communicate privately in the sub-electronic meeting while maintaining their view of the main electronic meeting in progress.

### BACKGROUND OF THE INVENTION

Today's meetings have changed from the traditional face-to-face to the matrix model where a network, such as the Internet, is used along with an electronic meeting application. However, the actual meeting process remains the same. In electronic meetings, sometimes certain attendees in the meeting need to communicate with each other separately from the rest of the group. For example, in a meeting involving ten people, two attendees might need to share some information that is irrelevant to the other attendees in the meeting. In a normal e-meeting setup, when this conversation takes place, the other attendees of the meeting are idle. The subgroup that needs to communicate must use the same channel as the main e-meeting. This wastes time and renders these meetings inefficient.

### BRIEF SUMMARY OF THE INVENTION

The exemplary embodiment provides a method and system for providing separate channels for sub-electronic meetings within a main electronic meeting. In one aspect, a method according to the exemplary embodiment comprises: providing the main electronic meeting for a group of attendees over a first channel in a network, the main electronic meeting being managed by a moderator; sending a request from the moderator to an electronic meeting service to create at least one sub-electronic meeting for at least one subgroup of attendees; and providing the sub-electronic meeting over a separate second channel in the network for the subgroup of attendees, the sub-electronic meeting occurring simultaneously within the main electronic meeting without disconnecting the subgroup of attendees from the main electronic meeting.

In another aspect, a method according to the exemplary embodiment comprises: providing a first graphic user interface (GUI) comprising a first shared meeting space for a main electronic meeting to each of a group of attendees of the main electronic meeting, the electronic meeting being provided over a first channel in a network, the main electronic meeting being managed by a moderator; providing a second GUI comprising a second shared meeting space for a sub-electronic meeting to each of a subgroup of attendees, the sub-electronic meeting being provided over a separate second channel in the network, the sub-electronic meeting occurring simultaneously within the main electronic meeting without disconnecting the subgroup of attendees from the main electronic meeting.

In another aspect, the exemplary embodiment is implemented in a computer program product comprising a computer useable medium having a computer readable program, wherein the computer readable program when executed on a computer causes the computer to provide the above.

### BRIEF DESCRIPTION OF THE SEVERAL VIEWS OF THE FIGURES

FIG. 1 illustrates an exemplary system for allocating separate channels of sub-electronic meetings.

FIG. 2 illustrates an exemplary method for allocating separate channels of sub-electronic meetings.

FIG. 3 illustrates exemplary GUIs according to the exemplary embodiment.

FIG. 4 illustrates a hierarchy of electronic meetings.

FIG. 5 illustrates exemplary GUIs for a hierarchy of electronic meetings.

### DETAILED DESCRIPTION OF THE INVENTION

The exemplary embodiment provides a method and system for providing separate channels for sub-electronic meetings within a main electronic meeting. The following description is presented to enable one of ordinary skill in the art to make and use the invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

The method and system according to the exemplary embodiment allows a moderator of a main electronic meeting to request, and an electronic meeting service to allocate, separate channels of sub-electronic meetings, occurring within the main electronic meeting, for a subgroup of attendees of the main electronic meeting, without disconnecting the subgroup of attendees from the main electronic meeting. The sub-electronic meetings occur simultaneously within the main electronic meeting. The subgroup of attendees is then able to communicate privately in the sub-electronic meeting while maintaining their view of the main electronic meeting in progress. In this manner, the main electronic meeting can occur such that idle time for the attendees is minimized.

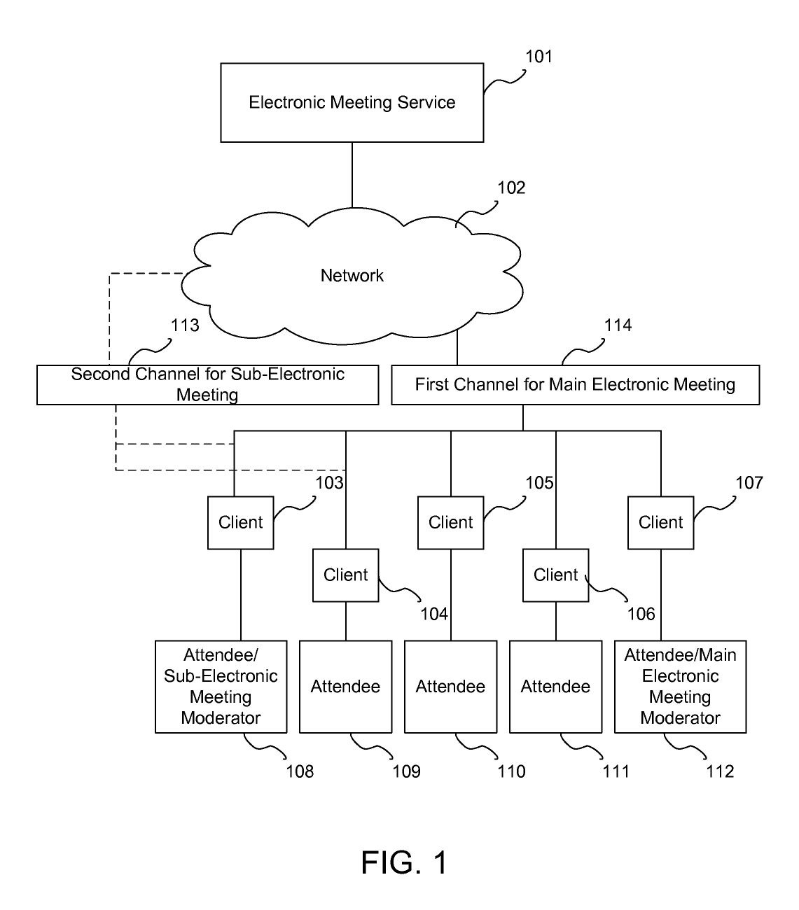

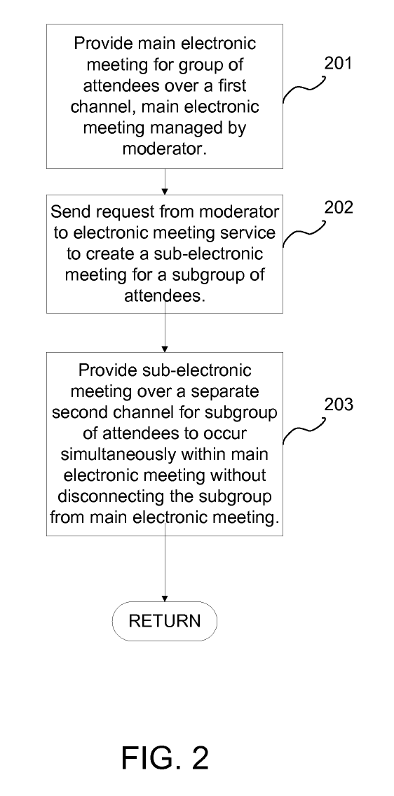

FIGS. 1 and 2 illustrate an exemplary system and method, respectively, for allocating separate channels of sub-electronic meetings. Referring to both FIGS. 1 and 2, the system includes an electronic meeting service 101 provided over a network 102 to a plurality of clients 103-107. The electronic meeting service 101 provides at the clients 103-107 a main electronic meeting for a group of attendees 108-112 over a first channel 114 (step 201). One of the attendees 112 functions as a moderator with full authority to manage the electronic meeting. The moderator 112 can set parameters for the main electronic meeting, such as length of time, maximum number of attendees, etc. The main electronic meeting includes a visual component and an audio component. The visual component includes a GUI provided by an electronic meeting application (not shown) at each of the clients 103-107. The audio component can be provided through the network 102, such as voice over IP (VOIP), or through a separate service, such as a telephone.

The moderator 112 can initiate a sub-electronic meeting for a subgroup of attendees without being a participant of the sub-electronic meeting and have full authority over the sub-electronic meeting. Any of the other attendees 108-111 can initiate a sub-electronic meeting by sending a request to the moderator 112 of the main electronic meeting. The moderator 112 can accept, reject, or postpone the request. If the moderator 112 accepts the request for a sub-electronic meeting, then the moderator 112 sends a request to the electronic meeting service 101 to create the sub-electronic meeting (step 202). The electronic meeting service 101 creates the separate second channel 113 in the network 102 for the sub-electronic meeting. The sub-electronic meeting is provided over the second channel 113 to the subgroup of attendees to occur simultaneously within the main electronic meeting, without disconnecting the subgroup from the main electronic meeting (step 203). For example, if the network 102 is the Internet and the electronic meeting service 101 is VOIP, then the first and second channels 113-114 are separate threads.

In the exemplary embodiment, the moderator 102 has access to information on the system's bandwidth or other system resources, so that the moderator 102 would not request a sub-electronic meeting that would overload the system. Optionally, in response to the request to create the sub-electronic meeting from the monitor 102, the moderator 192 is informed whether creating the sub-electronic meeting would overload the system.

In the exemplary embodiment, the requester of the sub-electronic meeting functions as the moderator of the sub-electronic meeting. For example, attendee 108 can request the sub-electronic meeting for him or herself and attendee 109. Attendee 108 would be the moderator for the sub-electronic meeting with full authority over the sub-electronic meeting. As the moderator, attendee 108 can set parameters for the sub-electronic meeting. The moderator 112 of the main electronic meeting would have the same moderator rights for the sub-electronic meeting as for the main electronic meeting. These rights include the ability to cancel the sub-electronic meeting and return the sub-electronic meeting participants to the main electronic meeting. Thus, as illustrated in FIG. 1, clients 103-104 for attendees 108-109 are connected to both the first channel 114 for the main electronic meeting and the second channel 113 for the sub-electronic meeting. The sub-electronic meeting attendees 108-109 can now communicate privately using the second channel 113 while still being able to view or monitor the main electronic meeting over the first channel 114.

Contrary to known teleconferencing or electronic meeting approaches, the moderator or attendee of an electronic meeting is able to initiate a sub-electronic meeting that results in the electronic meeting service 101 creating a separate channel for others to participate in the sub-electronic meeting. In known teleconferencing or e-meeting approaches, a moderator or an attendee only has the ability to create separate channels for themselves but not for others.

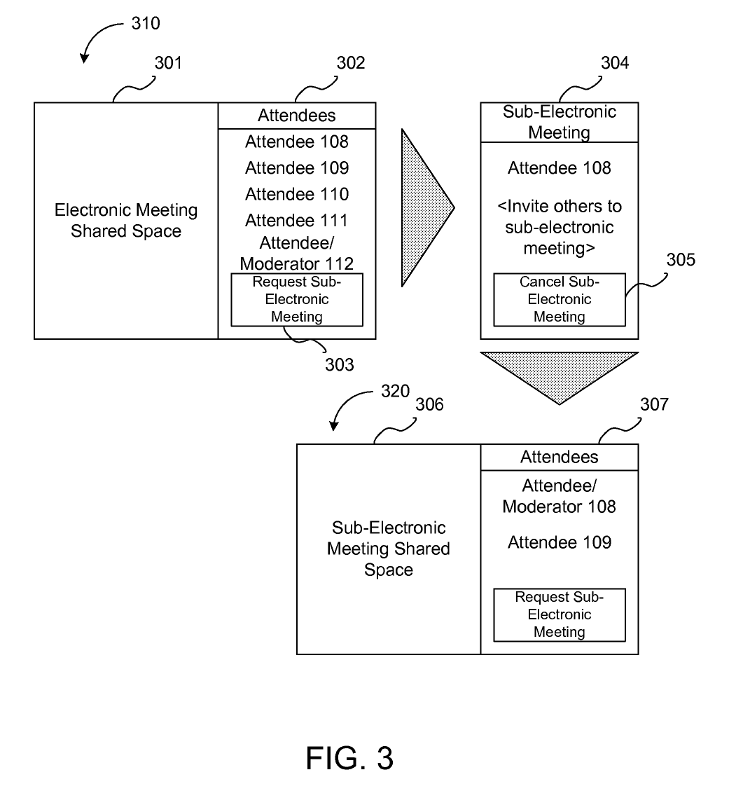

FIG. 3 illustrates exemplary GUIs according to the exemplary embodiment. When the main electronic meeting is provided over the first channel 114, electronic meeting applications at the clients 103-107 display an electronic meeting GUI 310 with an electronic meeting shared space 301 to each attendee 108-112 (step 201). The GUI 310 also displays a list of attendees 302 of the main electronic meeting. The attendees 108-112 visually communicate during the main electronic meeting through the electronic meeting shared space 301 and audibly through an audio channel, such as a VOIP, cellular, wireless, or telephone channel.

The GUI 310 also includes a Request Sub-Electronic Meeting button 303. To create a sub-electronic meeting, the moderator 112 selects the button 303. Alternatively, one of the attendees selects the button 303 to request that the moderator 112 create the sub-electronic meeting. A sub-electronic meeting GUI 304 is displayed at the client of the requesting party. The requesting party selects the attendees to invite to the sub-electronic meeting. The requesting party can drag and drop attendees from the list 302 to the GUI 304, use a “send to” function, or some other similar means. For example, attendee 108 requests the sub-e-meeting and invites attendee 109. The sub-electronic meeting request process can be canceled at any time by selecting the Cancel Sub-Electronic Meeting button 305. If the moderator 112 accepts the attendee 108's request for the sub-electronic meeting, then an invitation is sent to the attendee 109. Upon receiving the invitation, attendee 109 can decide to accept or decline the invitation.

Once the attendee 109 accepts the invitation, a request for the sub-electronic meeting is sent to the electronic meeting service 101 (step 202). The electronic meeting service 101 creates a sub-electronic meeting over the second channel 113 for the subgroup of attendees 108-109. At the clients 103-104 for these attendees 108-109 the electronic meeting application displays a second electronic meeting GUI 320 with a sub-electronic meeting shared space 306 and a list of the attendees 307 (step 203). The GUI 320 can be displayed along with attributes of the sub-electronic meeting as set by the moderator of the sub-electronic meeting, such as time remaining and level of voice activities. Attendees of the main electronic meeting who are not participating in the sub-electronic meeting are not able to view the GUI 320. The moderator 112 of the main electronic meeting is either an active or a passive participant of the sub-electronic meeting and thus can view the second electronic meeting GUI 320 at client 107. In the exemplary embodiment, the GUIs 310 and 320 are displayed simultaneously for the subgroup of attendees 108-109. The subgroup of attendees 108-109 thus are able to participate in the sub-electronic meeting while maintaining their view of the main electronic meeting. When the sub-electronic meeting concludes, the electronic meeting service 101 discontinues the second channel 113.

Although FIGS. 1 and 2 illustrate one sub-electronic meeting under the main electronic meeting, multiple sub-electronic meetings for multiple subgroups of attendees can be provided under the main electronic meeting over multiple separate channels. In the exemplary embodiment, an attendee can be an active participant of only one sub-electronic meeting at a time, but can be a passive participant in any other sub-electronic meetings for which he or she is an attendee.

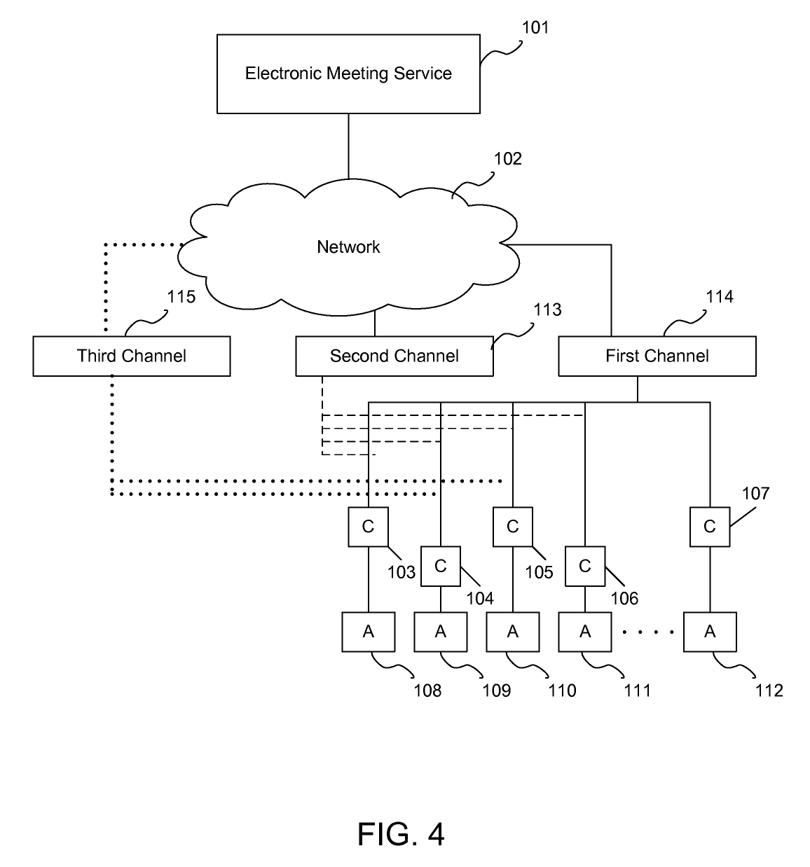

The sub-electronic meetings can also be hierarchical. FIG. 4 illustrates a hierarchy of electronic meetings. If attendees 108-111 are attendees of a sub-electronic meeting over a second channel 113, attendee 109 can initiate a second sub-electronic meeting under the first sub-electronic meeting for him or herself and attendee 110. Attendee 109 would be the moderator of the second sub-electronic meeting. This second sub-electronic meeting would be provided by the electronic meeting service 101 over a separate third channel 115. The moderator 108 of the first sub-electronic meeting would have moderator rights in the second sub-electronic meeting, and the moderator 112 of the main electronic meeting would have moderator rights in both the first and the second sub-electronic meetings. While attendees 109-110 are actively participating in the second sub-electronic meeting, they are passive participants in the first sub-electronic meeting.

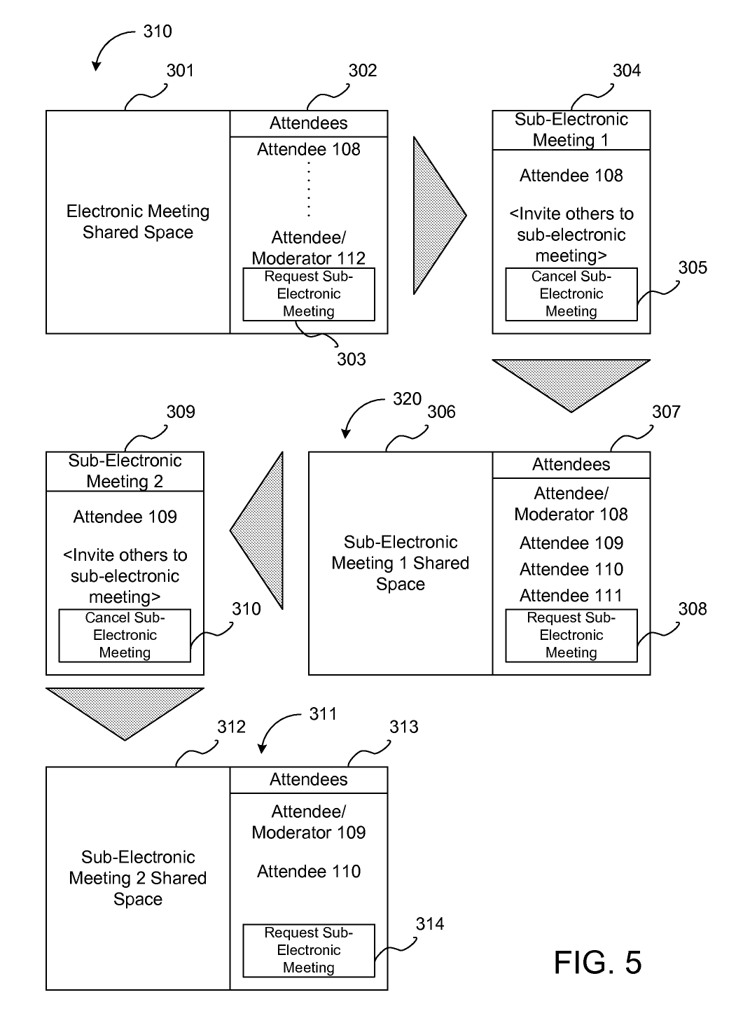

FIG. 5 illustrates exemplary GUIs for a hierarchy of electronic meetings. When the main electronic meeting is provided over the first channel 114, electronic meeting applications at the clients 103-107 display the GUI 310 with an electronic meeting shared space 301 to each attendee 108-112 (step 201). The GUI 310 also displays a list of attendees 302 of the main electronic meeting.

To create the first sub-electronic meeting, one of the attendees of the main electronic meeting selects the Request Sub-Electronic Meeting button 303. A first sub-electronic meeting GUI 304 is displayed at the client of the requesting party. The requesting party selects the attendees from the list of attendees 302 of the main electronic meeting to invite to the first sub-electronic meeting. For example, the attendee 108 requests the first sub-electronic meeting and invites attendees 109-111. The sub-electronic meeting request process can be canceled at any time by selecting the Cancel Sub-Electronic Meeting button 305. If the moderator 112 accepts the attendee 108's request for the first sub-electronic meeting, then invitations are sent to the attendees 109-111. Upon receiving the invitations, each attendee 109-111 can decide to accept or decline the invitation.

Assuming that each attendee 109-111 accepts the invitation, a request for the first sub-electronic meeting is sent to the electronic meeting service 101 (step 202). The electronic meeting service 101 creates the first sub-electronic meeting over the second channel 113 for the attendees 108-111. At the clients 103-106 for these attendees 108-111, the electronic meeting application displays a second electronic meeting GUI 320 with a sub-electronic meeting shared space 306 and a list of the attendees 307 (step 203). The GUI 320 can be displayed along with attributes of the first sub-electronic meeting as set by the moderator of the first sub-electronic meeting. Attendees of the main electronic meeting who are not participating in the first sub-electronic meeting are not able to view the GUI 320. In the exemplary embodiment, the GUIs 310 and 320 are displayed simultaneously for the subgroup of attendees 108-111. The subgroup of attendees 108-111 thus are able to participate in the first sub-electronic meeting while maintaining their views of the main electronic meeting. When the first sub-electronic meeting concludes, the electronic meeting service 101 discontinues the second channel 113.

To create a second sub-electronic meeting under the first sub-electronic meeting, one of the attendees of the first sub-electronic meeting selects the Request Sub-Electronic Meeting button 308. A sub-electronic meeting GUI 309 is displayed at the client of the requesting party. The requesting party selects the attendees from the list of attendees 307 of the first sub-electronic meeting to invite to the second sub-electronic meeting. For example, the attendee 109 requests the second sub-electronic meeting and invites attendee 110. The sub-electronic meeting request process can be canceled at any time by selecting the Cancel Sub-Electronic Meeting button 310. If the moderator 108 of the first sub-electronic meeting accepts the attendee 109's request for the second sub-electronic meeting, then an invitation is sent to the attendee 110. Upon receiving the invitation, attendee 110 can decide to accept or decline the invitation.

Assuming that attendee 110 accepts the invitation, a request for the second sub-electronic meeting is sent to the electronic meeting service 101 (step 202). The electronic meeting service 101 creates the second sub-electronic meeting over the third channel 115 for the attendees 109-110. At the clients 104-105 for these attendees 109-110, the electronic meeting application displays a third electronic meeting GUI 311 with a second sub-electronic meeting shared space 312 and a list of the attendees 313 (step 203). The GUI 311 can be displayed along with attributes of the second sub-electronic meeting as set by the moderator of the second sub-electronic meeting. Attendees of the main electronic meeting and the first sub-electronic meeting who are not participating in the second sub-electronic meeting are not able to view the GUI 311. In the exemplary embodiment, the GUIs 310, 320, and 311 are displayed simultaneously for the subgroup of attendees 109-110. The subgroup of attendees 109-110 thus are able to participate in the second sub-electronic meeting while maintaining their views of the first sub-electronic meeting and the main electronic meeting. When the second sub-electronic meeting concludes, the electronic meeting service 101 discontinues the third channel 115.

In one exemplary embodiment, the attendees of an electronic meeting can be set with a hierarchy of permissions. Example permissions include the ability to initiate sub-electronic meetings, ability to invite others to sub-electronic meetings, ability to join a sub-electronic meeting without invitation, and/or ability to leave the sub-electronic meeting prior to conclusion of the sub-electronic meeting. The hierarchy of permissions can be mapped to a Lightweight Directory Access Protocol (LDAP) directory service of an organization. Attendees higher up in the organizational hierarchy would be given greater permissions than those lower in the organizational hierarchy.

In one example scenario, assume that David has arranged for an electronic meeting with several members of this department who are geographically dispersed. Attendees of this main electronic-meeting includes David as participant/moderator and John, Sarah, Peter, and Jane as participants. The electronic meeting service 101 provides the electronic meeting over the first channel 114. An electronic meeting GUI 310 is displayed to David, John, Sarah, Peter, and Jane. During this main electronic meeting, David explains that there is an urgent customer service issue and asks Peter to find the answer to a question while the rest of the group continues their discussion. Peter realizes that he cannot answer the question alone and needs help from Sarah who is an expert. Peter initiates a sub-electronic meeting by selecting the Request Sub-Electronic Meeting button 303. David accepts Peter's request to create the sub-electronic meeting, and the sub-electronic meeting GUI 304 is displayed to Peter, who drags Sarah's name into the GUI 304 so that they can communicate privately without disturbing the main meeting. An invitation to join the sub-electronic meeting is sent to Sarah, who accepts. The sub-electronic meeting is then created by the electronic meeting service 101 for Peter and Sarah over a separate second channel 113 with Peter as the moderator of the sub-electronic meeting. The electronic meeting GUI 320 for the sub-electronic meeting is displayed to Peter and Sarah but not to John and Jane. Thus, the sub-electronic meeting feature of the exemplary embodiment leads to better time management. Peter can get to work right away without having to wait for the main electronic meeting to end. He can take advantage of Sarah's presence at the main electronic meeting.

In another example scenario, a workshop that is being conducted through an electronic meeting is underway over the first channel 114. The electronic meeting GUI 310 is displayed to each participant in the workshop. The facilitator has divided the attendees into subgroups that must report their results back in the main electronic meeting within two hours. Each subgroup has a leader. These leaders each initiate a sub-electronic meeting for those in their respective group. The electronic meeting service 101 creates a separate channel for each sub-electronic meeting. The appropriate electronic meeting GUI 320 is displayed to the appropriate sub-electronic meeting attendees. At the end of the two hours, the leaders close their sub-electronic meetings and return to the main electronic meeting. Thus, the sub-electronic meeting feature of the exemplary embodiment enables large workshops to be conducted more efficiently.

Other scenarios are possible without departing from the spirit and scope of the exemplary embodiment. Examples include but are not limited to contract negotiations where the buyer and seller want to communicate privately among their own group while negotiating, and mediations where during a dispute, a mediator may want to meet privately with one of the parties.

A method and system for providing separate channels for sub-electronic meetings within a main electronic meeting have been disclosed. The method and system provides the main electronic meeting for a group of attendees over a first channel in a network, the main electronic meeting being managed by a moderator; sends a request from the moderator to an electronic meeting service to create at least one sub-electronic meeting for at least one subgroup of attendees; and provides the sub-electronic meeting over a separate second channel in the network for the subgroup of attendees, the sub-electronic meeting occurring simultaneously within the main electronic meeting without disconnecting the subgroup of attendees from the main electronic meeting. A first graphic user interface (GUI) comprising a first shared meeting space for a main electronic meeting is provided to each of a group of attendees of the main electronic meeting. A second GUI comprising a second shared meeting space for a sub-electronic meeting is provided to each of a subgroup of attendees. Attendees of the main electronic meeting who is not a participant in the sub-electronic meeting cannot view the second GUI. The subgroup of attendees is able to communicate privately in the sub-electronic meeting while maintaining their view of the main electronic meeting in progress. In this manner, the main electronic meeting can occur such that idle time for the attendees is minimized.

The exemplary embodiment can take the form of an entirely hardware embodiment, an entirely software embodiment or an embodiment containing both hardware and software elements. In a preferred embodiment, the exemplary embodiment is implemented in software, which includes but is not limited to firmware, resident software, microcode, etc.

Furthermore, the exemplary embodiment can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but no limited to keyboards, displays, point devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for providing a sub-electronic meeting within a main electronic meeting, comprising:
providing the main electronic meeting for a group of attendees over a first channel in a network, the main electronic meeting being managed by a moderator;
sending a request from the moderator to an electronic meeting service to create at least one sub-electronic meeting for at least one subgroup of attendees; and
providing the sub-electronic meeting over a separate second channel in the network for the subgroup of attendees, the sub-electronic meeting occurring simultaneously within the main electronic meeting without disconnecting the subgroup of attendees from the main electronic meeting.

2. The method of claim 1, wherein the moderator of the main electronic meeting initiates the request for the sub-electronic meeting without being part of the subgroup of attendees.

3. The method of claim 1, wherein the sending comprises:
receiving by the moderator from one of the group of attendees a request to initiate the sub-electronic meeting; and
in response to an acceptance of the request by the moderator, sending the request from the moderator to the electronic meeting service to create the sub-electronic meeting.

4. The method of claim 3, wherein the initiating attendee being a moderator of the sub-electronic meeting.

5. The method of claim 3, wherein the receiving comprises:
determining by the initiating attendee invitees to the sub-electronic meeting from the group of attendees of the main electronic meeting; and
sending invitations to the invitees to join the sub-electronic meeting.

6. The method of claim 5, wherein each invitee can accept or reject the invitation to join the sub-electronic meeting.

7. The method of claim 1, wherein the sending comprises:
sending a plurality of requests from the moderator to the electronic meeting service to create a plurality of sub-electronic meetings for a plurality of subgroups of the attendees.

8. The method of claim 7, wherein the providing the sub-electronic meeting comprises:
providing the plurality of sub-electronic meetings over a plurality of separate channels in the network for the plurality of subgroups of the attendees, each sub-electronic meeting occurring simultaneously within the main electronic meeting without disconnecting the corresponding subgroup of attendees from the main electronic meeting.

9. The method of claim 1, wherein the sending comprising:
sending a request from the moderator of the main electronic meeting to the electronic meeting service to create a first sub-electronic meeting for the subgroup of attendees of the main electronic meeting; and;
sending a request from a moderator of the first sub-electronic meeting to the first electronic meeting service to create a second sub-electronic meeting under the first sub-electronic meeting for a subgroup of the attendees of the first sub-electronic meeting.

10. The method of claim 9, wherein the providing the sub-electronic meeting comprises:
providing the first sub-electronic meeting over the separate second channel in the network for the attendees of the first sub-electronic meeting, the first sub-electronic meeting occurring simultaneously within the main electronic meeting without disconnecting the attendees of the first sub-electronic meeting from the main electronic meeting; and
providing the second sub-electronic meeting over a separate third channel in the network for the attendees of the second sub-electronic meeting, the second sub-electronic meeting occurring simultaneously within the first sub-electronic meeting and the main electronic meeting without disconnecting the attendees of the second sub-electronic meeting from the first sub-electronic meeting or the main electronic meeting.

11. The method of claim 1, comprising:
providing a first graphic user interface (GUI) comprising a first shared meeting space for the main electronic meeting to each of the attendees of the main electronic meeting; and
providing a second GUI comprising a second shared meeting space for the sub-electronic meeting to each of the attendees of the sub-electronic meeting,
wherein the first GUI and the second GUI are displayed simultaneously for the attendees of the sub-electronic meeting.

12. The method of claim 8, comprising:
a first graphic user interface (GUI) comprising a first shared meeting space for the main electronic meeting to each of the attendees of the main electronic meeting; and
providing a second GUI comprising a second shared meeting space for each of the plurality of sub-electronic meetings to each of the attendees of the corresponding sub-electronic meeting,
wherein for each attendee of the corresponding sub-electronic meeting, the first GUI and the second GUI are displayed simultaneously.

13. The method of claim 9, comprising:
providing a first graphic user interface (GUI) comprising a first shared meeting space for the main electronic meeting to each of the attendees of the main electronic meeting;
providing a second GUI comprising a second shared meeting space for the first sub-electronic meeting to each of the attendees of the first sub-electronic meeting, wherein the first GUI and the second GUI are displayed simultaneously for the attendees of the first sub-electronic meeting; and
providing a third GUI comprising a third shared meeting space for the second sub-electronic meeting to each of the attendees of the second sub-electronic meeting, wherein the first GUI, the second GUI, and the third GUI are displayed simultaneously for the attendees of the second sub-electronic meeting.

14. A method for providing a sub-electronic meeting within a main electronic meeting, comprising:
providing a first graphic user interface (GUI) comprising a first shared meeting space for a main electronic meeting to each of a group of attendees of the main electronic meeting, the electronic meeting being provided over a first channel in a network, the main electronic meeting being managed by a moderator; and
providing a second GUI comprising a second shared meeting space for a sub-electronic meeting to each of a subgroup of attendees, the sub-electronic meeting being provided over a separate second channel in the network, the sub-electronic meeting occurring simultaneously within the main electronic meeting without disconnecting the subgroup of attendees from the main electronic meeting.

15. The method of claim 14, wherein the providing the second GUI comprises:
providing the second GUI for each of a plurality of sub-electronic meetings to each attendee of the corresponding sub-electronic meeting,
wherein each sub-electronic meeting is provided over a separate channel in the network, each sub-electronic meeting occurring simultaneously within the main electronic meeting without disconnecting the attendees for the sub-electronic meetings from the main electronic meeting,
wherein for each attendee of the corresponding sub-electronic meeting, the first GUI and the second GUI are displayed simultaneously.

16. The method of claim 15, wherein the providing the second GUI comprises:
providing the second GUI comprising the second shared meeting space for a first sub-electronic meeting to each attendee of the first sub-electronic meeting, wherein the first GUI and the second GUI are displayed simultaneously for the attendees of the first sub-electronic meeting; and
providing a third GUI comprising a third shared meeting space for a second sub-electronic meeting to each attendee of the second sub-electronic meeting,
wherein the second sub-electronic meeting is provided over a separate third channel in the network, the second sub-electronic meeting occurring simultaneously within the first sub-electronic meeting and the main electronic meeting without disconnecting the attendees for the second sub-electronic meetings from the first sub-electronic meeting or the main electronic meeting,
wherein the first GUI, the second GUI, and the third GUI are displayed simultaneously for the attendees of the second sub-electronic meeting.

17. A computer program product comprising a computer useable medium having a computer readable program for providing a sub-electronic meeting within a main electronic meeting, wherein the computer readable program when executed on a computer causes the computer to:
provide the main electronic meeting for a group of attendees over a first channel in a network, the main electronic meeting being managed by a moderator;
send a request from the moderator to an electronic meeting service to create at least one sub-electronic meeting for at least one subgroup of attendees; and
provide the sub-electronic meeting over a separate second channel in the network for the subgroup of attendees, the sub-electronic meeting occurring simultaneously within the main electronic meeting without disconnecting the subgroup of attendees from the main electronic meeting.

18. A computer program product comprising a computer useable medium having a computer readable program for providing a sub-electronic meeting within a main electronic meeting, wherein the computer readable program when executed on a computer causes the computer to:
provide a first graphic user interface (GUI) comprising a first shared meeting space for a main electronic meeting to each of a group of attendees of the main electronic meeting, the electronic meeting being provided over a first channel in a network, the main electronic meeting being managed by a moderator; and
provide a second GUI comprising a second shared meeting space for a sub-electronic meeting to each of a subgroup of attendees, the sub-electronic meeting being provided over a separate second channel in the network, the sub-electronic meeting occurring simultaneously within the main electronic meeting without disconnecting the subgroup of attendees from the main electronic meeting.
